(19) United States
(12) Patent Application Publication
(10) Pub. No.: US 2010/0211488 A1
(43) Pub. Date: Aug. 19, 2010

(54) LICENSE ENFORCEMENT

(75) Inventors: Stephen McSpadden, East Kilbride (GB); Barry Hochfield, East Kilbride (GB)

Correspondence Address: MOORE & VAN ALLEN PLLC, P.O. BOX 13706, Research Triangle Park, NC, 27709, US

(73) Assignee: ITI Scotland Limited, Glasgow (GB)

(21) Appl. No.: 12/669,355

(22) PCT Filed: Jul. 18, 2008
(86) PCT No.: PCT/GB2008/002468

§ 371 Date: Jan. 28, 2010

(30) Foreign Application Priority Data
Jul. 18, 2007 (GB) 0713988.4

(51) Int. Cl. G06Q 99/00; G06Q 30/00; G06Q 20/00; G06F 21/24

(52) U.S. Cl. 705/34; 705/40; 705/310; 726/29

(57) ABSTRACT

A brand protection feature reader and/or writer instrument (6) that is adapted to perform a pre-determined number of operations, for example authentication of a brand protection feature, and prevent subsequent operations from being performed if the pre-determined number of operations is exceeded. A counter (70) may be provided for counting the number of operations performed, thereby to determine if the pre-determined number of operations is exceeded.

The present invention relates to a method and apparatus for enforcing licences in a brand protection management system (BPMS). In particular, the present invention relates to a security feature reader/writer with an integrated secure application module and licence enforcement system.

### BACKGROUND OF THE INVENTION

PCT/GB2007/001248, the contents of which are incorporated herein by reference, describes a brand protection management system. In this, goods are provided with machine-readable tags that contain authentication information. The authentication information is read from the tags using a tag reader and compared with stored authentication data, thereby to determine the authenticity or otherwise of the goods.

Because of the globalisation of many markets, in practice, the system of PCT/GB2007/001248 will be distributed over a wide geographical area. As will be appreciated, managing this is complex and requires high-level security features. One aspect with particular security concerns is in relation to how the brand owners are billed for using the system.

### SUMMARY OF THE INVENTION

According to a first aspect of the present invention, a brand owner or system user may be issued with a licence for unlimited usage of a brand management or authentication system within one or more specified time periods or the number of authentications could be monitored and the brand owner billed accordingly. In either case, security is important for both the system provider and the brand owner.

To allow usage to be monitored, in accordance with the invention there is provided a brand protection/taggant reader and/or writer instrument for use in a brand protection management system, the instrument being operable to perform a pre-determined number of operations and prevent subsequent operations from being performed if the pre-determined number of operations is exceeded. The operation may be at least one of: authentication of a brand protection feature/taggant and issuing or registration of a brand protection feature/taggant.

By controlling the number of operations performed, the instrument may be operated offline without the need to refer to a central server whilst still maintaining enforcement of the licensing conditions and revenue generation for the system provider. This is because usage can be licensed on a “per operation” basis, allowing the system operator to charge in advance for services. An advantage of this is that in the event that security is compromised, the number of offline authentications performed is limited before the instrument is incapacitated.

In addition to restricting the number of goods authenticated by unauthorised parties, the limited number of operations or limited time period over which operations can be performed prevents a large number of fictitious authentication requests being sent to the instrument and/or brand protection management system in order to investigate its security measures. This increases the security of the system.

The instrument may be a reader for reading the security feature and/or writer for writing the security feature. The operation may be to check whether a scanned security feature, for example a machine-readable tag, is authentic. Additionally or alternatively, the operation may involve the issuing of a security feature, such as a machine-readable tag.

The instrument may be operable to read one or more types of machine readable taggants/brand protection features. Such taggants may, for example, include barcodes, one dimensional or two dimensional, RFID tags, fluorescent tags, or any other suitable taggant types.

In most cases the machine readable brand protection features/taggants will be physically attached to, or otherwise incorporated in, the articles to be authenticated/managed. In some cases the brand protection feature/taggant may simply comprise an inherent feature of the article itself which the brand protection feature/taggant instrument is configured to read, e.g. a visible or covert feature which the reader means is designed to detect/read. Therefore, for the avoidance of doubt, it will be understood that the terms “brand protection feature” or “taggant” as used herein are not intended to be limited to physical tags or markers attached to articles to be authenticated but are intended to also include visible or covert features inherent in an article itself.

A counter for monitoring the predetermined number of operations may be provided. This may be located remotely from the instrument, in which case the instrument is configured to contact the remote location.

Alternatively, the counter may be provided within the instrument, for example within an instrument based secure application module (SAM). The counter may reside in a SAM that is also adapted to perform an authentication and/or registration operation. By utilising the secure processing and storage abilities of an existing SAM to operate the counter, the component count of the instrument may be minimised and the counter may be stored and operated in a secure environment.

The counter may be located in a dedicated licence control SAM. This would allow the system supplier to ensure that the counter is protected in a system not having the required degree of security or only having limited secure processing capacity.

The counter may be adapted to require authentication before being updated to reflect an increased number of allowable of operations, i.e. topped-up. Access to update the counter to increase the available authentications may be via mutual authentication using key encryption. The counter may be adapted to receive updates from a trust management system of a brand protection management system. The counter may be adapted to receive updates from a secondary trust management system dedicated to operating access to the counter.

The SAM may be configured to return an error code if the counter is within a predefined number of operations of a threshold. The instrument may be adapted to issue a warning if the counter is within a predefined number of operations of the threshold.

The counter may be adapted to allow read only access by the instrument but require authentication for write access.

The counter may be associated with a brand owner and/or an instrument and/or a user and/of an operation and/or a security feature.

Multiple counters may be provided, either at the instrument or remotely thereof. The instrument may be adapted to determine which counter to use by obtaining such information from the instrument, a user or from a tag. By being able to control the associations of the counter and by operating each counter at instrument level an increased degree of flexibility in management of the system is obtained.

According to another aspect of the invention, there is provided a secure application module (SAM) for monitoring the number of operations performed by a brand protection feature reader and/or writer; comparing the number performed with a pre-determined number of allowed operations, and generating a signal to prevent the instrument from performing more operations in the event that the actual number of operations exceeds the pre-determined number of operations. The secure application module may be resident in the instrument or may be removable.

According to a third aspect of the present invention, there is provided a system for collecting authentication data from instruments according to the first aspect of the invention and/or to control revenue collection via a SAM according to the second aspect.

According to a fourth aspect of the present invention, there is provided a method for collecting revenue in a BPMS; including providing at least one counter for counting operations performed by the BPMS; providing threshold limits; receiving a request to perform an operation; comparing the value of the counter with the threshold limits; performing the requested operation or permit the requested operation to be performed only if the counter is within the threshold limits; and updating the counter to reflect the requested action having been performed.

### BRIEF DESCRIPTION OF THE DRAWINGS

The present invention will be described by way of example only with reference to the following drawings, of which:

FIG. 1 is a block diagram of a brand protection management system;

FIG. 2 shows a schematic of an authentication instrument for use with a brand protection management system;

FIG. 3 shows a schematic of an alternative authentication instrument for use with a brand protection management system; and

FIG. 4 shows a schematic of a process for initializing a security tag using the instrument of FIG. 2.

### DETAILED DESCRIPTION OF THE DRAWINGS

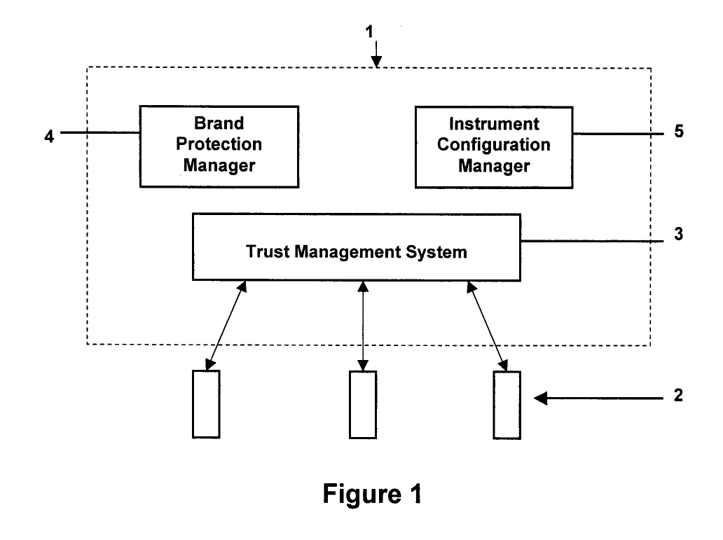

FIG. 1 shows a brand protection management system in accordance with the teachings of PCT/GB2007/001248. This has a brand protection server 1 that can communicate with point of registration (PoR) brand protection feature reader/writer devices 2 and point of authentication (PoA) reader devices 2 provided at various locations in a product distribution chain. The reader devices include brand protection feature readers for reading brand protection features/taggants on articles that are to be authenticated. Such taggants may, for example, include barcodes, one dimensional or two dimensional, RFID tags, fluorescent tags, or any other suitable taggant types. The reader devices may include user authentication devices such as, for example, smart card readers, for reading user identification information provided by a user for authentication purposes. In some cases the reader devices may also have a write capability so that they can generate brand protection features, e.g. taggants in labels, as well as read them.

The PoR devices are capable of generating brand protection features to be applied to new, that is not previously authenticated, articles, at a start or “registration” point. The PoR and PoA devices communicate with the brand protection management server system using whatever standard communication method is most appropriate for them, e.g. TCP/IP over LAN for fixed devices, or WiFi for portable devices or GSM etc. One or more PoR reader/writer devices may be linked/served using local networking such as WiFi or Ethernet, to a single Point of Registration (PoR) control device, e.g. a client Personal Computer (PC). Similarly several PoA devices may be linked/served in a similar manner by a main PoA device, e.g. a client personal computer (PC). In the description below references to the “PoA/PoR instrument” shall be understood to mean a PoA device or a PoR device or a single instrument in which a PoR and PoA device are combined.

Included at the brand protection server 1 is a trust management system (TMS) 3 for ensuring security across the entire platform and a brand protection management system 4 for analysing and storing brand management data, and controlling brand related features or functions. Also provided at the server is an instrument configuration management system (ICMS) 5 for managing policies for control of each PoR and PoA instrument in the system. The policies include control or configuration information specifying, for example, the type of brand protection feature that is to be read, the type of processing that is to be used to authenticate a particular brand protection feature, the grade or role of user approved to use the reader, the workflow; that is the steps that a user who is operating the reader has to take; and any other brand protection feature reader information. Included in the ICMS is a component of the trust management system, typically implemented on a Hardware Security Module (HSM) or some other tamper proof security component. Data flows from the central TMS via this to the instruments in the field. To ensure local security, each PoR and PoA device includes its own trust management system component.

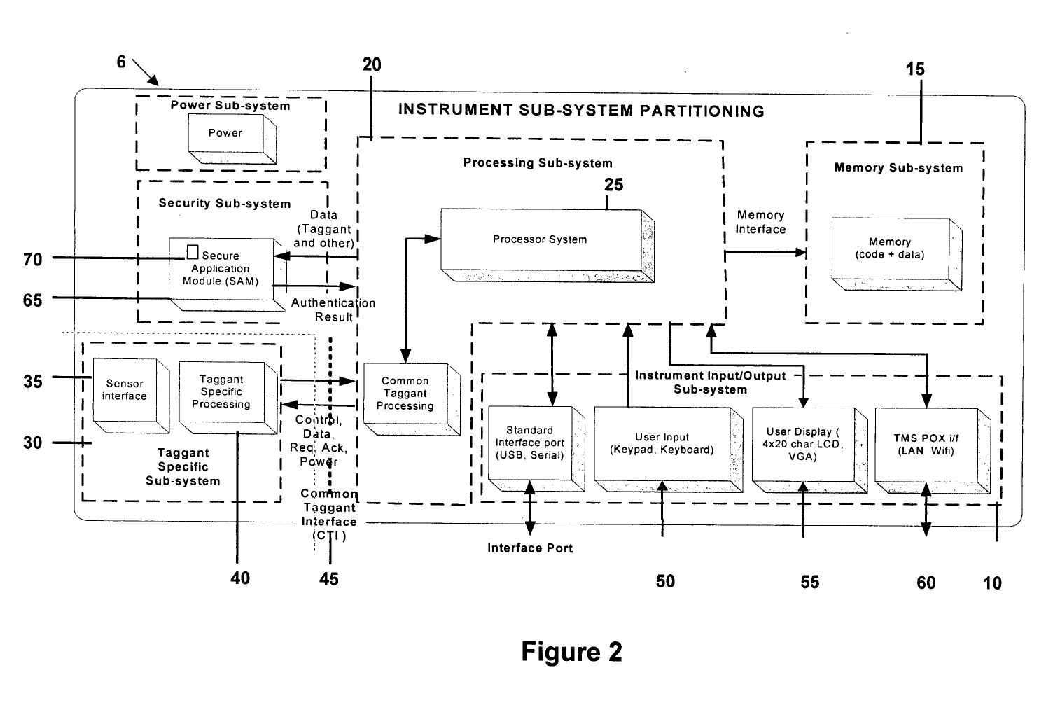

FIG. 2 illustrates an instrument 6 for use with a brand protection management system (BPMS). The instrument 6 is operable to interact with secure tags on goods or resources on behalf of the BPMS. The instrument 6 includes an input/output module 10, a memory 15, a core processing subsystem 20 that has a core processor 25 for controlling all processing operations in the instrument 6; a tag specific feature extraction and configuration block 30 and a security subsystem that has a secure application module (SAM) for storing, handling and/or processing sensitive information. Also provided is a power subsystem for powering all components of the device.

The input/output module 10 consists of a user input 50, which may be, for example, a keypad, smart card slot or biometric scanner and a user display 55. The instrument 6 is provided with an interface 60, which may, for example, be LAN or WiFi, for communicating with the TMS, which is typically physically located on a different geographical site to the instrument. The instrument storage facility 15 includes a data store for converted authentication data and a data store for configuration data, which sets the configuration of the brand protection feature extraction module 30. The configuration details include product IDs, authentication events, their parameters, their sequencing, what tag technologies are to be used, and whether there is a link between data read from one brand protection feature and another on the same product. The configuration data is downloaded to the instrument from the instrument configuration manager.

The tag specific feature extraction and configuration block 30 contains a sensor interface 35 and a tag specific processor 40. The sensor could, for example, be a barcode scanner, an RFID tag reader or any other chosen machine-readable tag reader and/or writer device. The sensor interface 35 and tag specific processor 40 control the sensor and process the data exchanged with the sensor to read from and/or write to a tag in order to extract identification information relating to the tag and/or to configure the tag. Data extracted from the tag is converted into a common platform format by a common brand protection feature interface 45 for communication to the rest of the instrument components and vice versa for communications from the instrument to the tag.

In order to maintain security, the instrument 6 includes a secure application module (SAM) for processing and controlling the communication of authentication data between the tag reader and brand protection management server. The SAM provides a physically and logically secure module for storing authentication information and/or at least partially processing authentication requests. The SAM 65 acts as a trust management agent for the BPMS and is adapted to process and store secure information for authenticating tags using, for example, tag features that have overlapping verifiable content, such as an encrypted check, for example, a MAC or digital signature. The SAM 65 also contains one or more credit counters 70 for storing the number of certain operations that have been pre-paid for by the system user. Where the instrument is to carry out operations for multiple users, each user is designated one or more dedicated counters so that their operations can be monitored independently of those associated with other users. The credit counter 70 is both stored and operated in a secure manner by the SAM 65 to provide an irrefutable method of validating the number of operations performed. Also provided in the SAM 65 is a counter for counting the number of failed operations, for example failed authentications.

In use, the SAM 65 is adapted to check the value of the counter 70 before certain operations, such as an authentication or security tag initialization, are carried out. The requested operation is only carried out if the number of operations allowed shown by the counter 70 is above zero. Once this threshold is reached, the instrument is essentially disabled for the operation associated with that particular counter. The SAM 65 is also adapted to decrement the counter 70 upon completion of an appropriate operation. In the event that the operation is not completed, the failed operation counter is incremented. Typically the failed operation counter is adapted to notify the SAM 65 when more than a pre-determined number of failed events occur. When this limit is reached, the instrument is disabled. This helps to prevent a stolen off-line authentication instrument from being used for attacks by asking the instrument to authenticate large numbers of data items in an attempt to learn the keys or other security parameters.

In order to avoid a device unexpectedly running out of credit, the SAM 65 may also store a warning threshold value. In this case, after decrementing the counter 70, the SAM 65 checks if the counter value is at, or below, the warning threshold value and if so, issues a warning type signal, which is communicated to the instrument user or operator as a “low credit” warning to arrange a top-up of credit.

The counter 70 may be accessed by the supplier of the BPMS or an authority responsible for collecting revenue from use of the system to update the counter 70 or to apply new credit to the counter 70. An access policy for accessing the counter 70 is controlled by the SAM 65. This requires mutual authentication of key material associated with the BPMS supplier. The operation of the access and associated authentication is carried out by the TMS utilising the TMS infrastructure. In an alternate arrangement, a separated or distributed TMS architecture whose sole purpose is license management could be provided. In this case, the SAM 65 is adapted to allow access to the counter after acceptance of the supplier's keys provided via secured messages generated by the separate licence management TMS architecture. This arrangement allows secure revenue collection in systems where there is separation between the service provider and the brand protection feature suppliers.

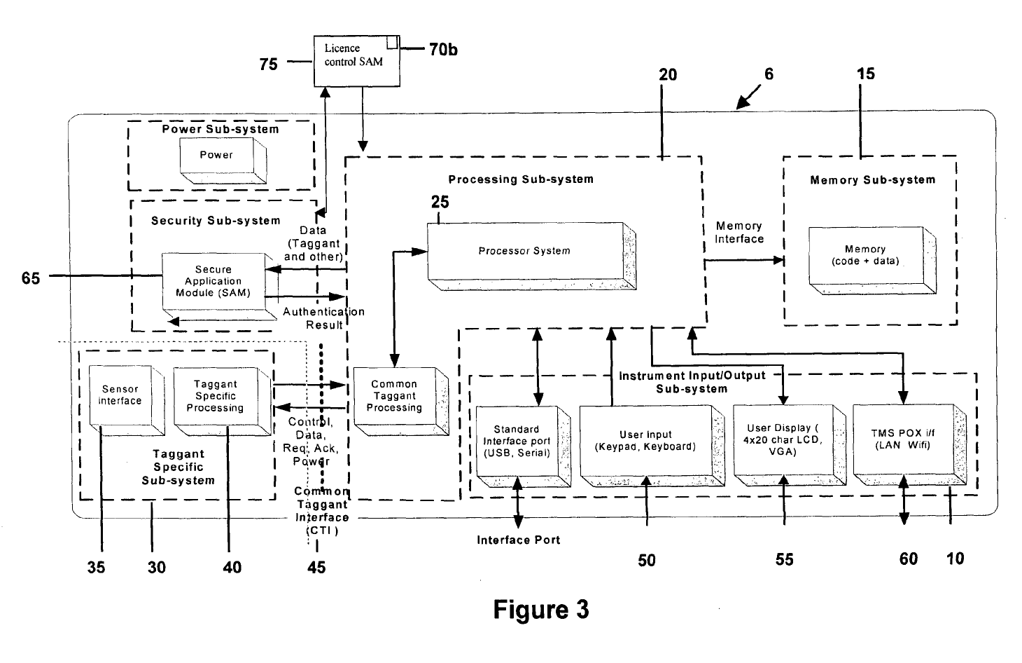

FIG. 3 shows a modified version of the instrument 6 of FIG. 2. In this case, a separate, preferably removable, licence control SAM 75 is provided, as well as the instrument based SAM 65. Included on the removable SAM is a counter 70b for monitoring the number of operations carried out, as well as a failed operation counter for monitoring the number of attempts that are made to complete an operation. In this embodiment, rather than obtain the credit value directly from a credit counter stored in its own memory, the instrument SAM 65 sends a message to the licence control SAM 75 to request permission to proceed with the operation. The licence control SAM 75 then queries the counter 70b, determines if there is sufficient credit in the counter 70b to perform the operation and either returns a “proceed” message to the instrument SAM 65 or sends a “no credit” error message to the instrument processor 20. The licence control SAM 75 is also adapted to adjust the value of the credit counter 70b appropriately upon successful completion of an operation.

The SAM 65 and/or 75 may be, for example, a smart card. There is a well defined set of specifications for SAMs and other Integrated Circuit Cards (ICC) that detail the electrical signals, communications protocols and Application Protocol Data Units (APDUs) that all such modules should be compatible with. The relevant ISO 7816 specifications are detailed in the following references: ISO/IEC ISO 7816-1, Identification cards—Integrated circuit(s) cards with contacts—Part 1: Physical characteristics, 1998 (Amendment 2003); ISO/IEC ISO 7816-2, Identification cards—Integrated circuit cards—Part 2: Cards with contacts—Dimensions and location of the contacts, 1999 (Amendment 2004); ISO/IEC ISO 7816-3, Information technology—Identification cards—Integrated circuit(s) cards with contacts—Part 3: Electronic signals and transmission protocols, 1997 (Amendment 2002); ISO/IEC ISO 7816-4, Identification cards—Integrated circuit cards—Part 4: Organization, security and commands for interchange, 2005; ISO/IEC ISO 7816-8, Identification cards—Integrated circuit(s) cards with contacts—Part 8: Commands for security operations, 2004, and ISO/IEC ISO 7816-11, Personal verification through biometric methods, 2004.

When the instrument of FIG. 2 or 3 is in use as an authenticating device, the user identifies themselves and the type of tag that is to be used, so that the tag specific processor 40 is able to identify the processing needed for the tag that is about to be scanned. The scan results in a representative signal in the sensor interface 35, which is communicated to the tag specific processing module 40 for tag specific first level processing and extraction of tag features. The tag signal is converted into the common data format and sent to the SAM 65 for examination for authenticity, thereby to provide off-line authentication of the tag.

Before examining for authenticity, the SAM 65 retrieves the value of the counter 70 or 70b. If there is insufficient credit indicated by the counter 70 or 70b, i.e. the counter is zero, then the SAM 65 returns an error signal, which is used to inform the user and/or licensee that insufficient credit available to perform the operation. If the counter 70 or 70b shows sufficient credit remaining, i.e. the counter value for that operation is above 0, then the SAM 65 proceeds with the authentication and a secure record of the event (pass/fail/date/time/operator etc.) is created in the SAM 65 by signing or encrypting it. The secure data is then stored in the instrument memory 15 and a header associated it is stored in the SAM 65. After the authentication by the SAM 65, the SAM 65 causes the counter 70 or 70b to be decremented to reflect that the appropriate operation has been performed. The SAM 65 then compares the new value of the counter 70 or 70b with a warning threshold value. If the new counter value is at, or below, the warning threshold value the SAM 65 issues a signal, which is interpreted by the instrument processor 25 and communicated to the instrument user or operator as a “low credit” warning that a top-up of credit should be arranged before the credit runs out. Alternately, read-only access to the counter 70 is granted to the instrument processor 25 to allow the value of the counter 70 to be communicated to the instrument user or the licensee or to provide a low credit warning.

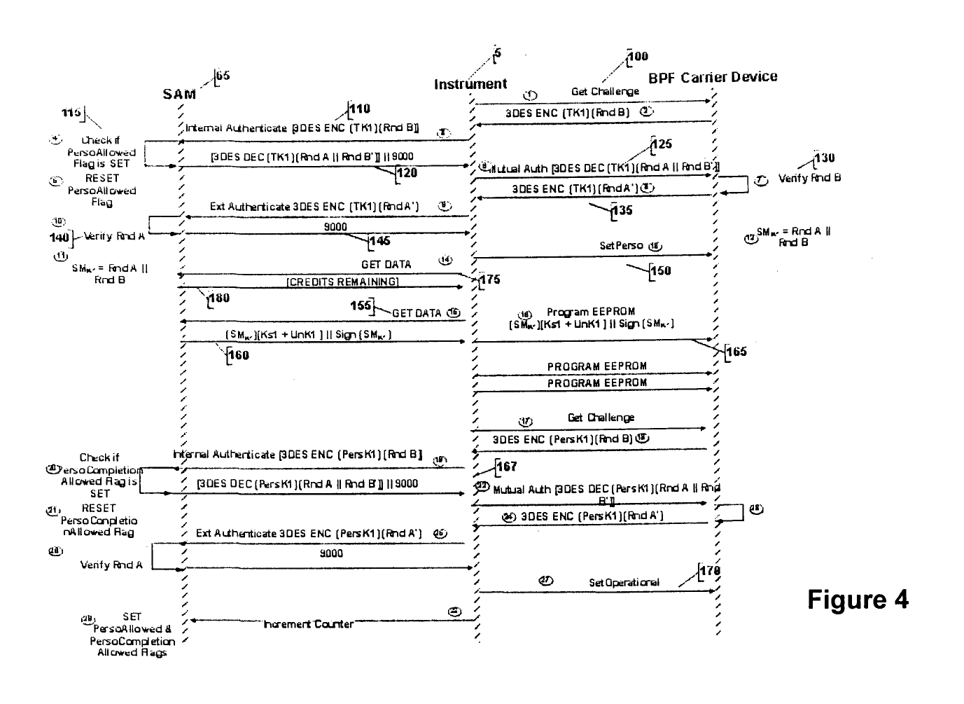

FIG. 4 shows the steps for issuing a micro-controller based brand protection feature (BPF) carrier device. Firstly, the BPF carrier device and the instrument 6 mutually authenticate each other. The instrument 6 sends a command to the BPF carrier device to initiate the authentication process 100. The BPF carrier device generates a random number and performs an encryption process on the random number using an appropriate key. The encrypted number is returned to the instrument 6. The instrument 6 sends a command to the SAM 65 to allow it to authenticate itself to the BPF carrier device, including the encrypted random number from the BPF carrier device (command 110). The SAM 65 checks a personalisation flag to see if personalisation of the tag is permitted 115. If personalisation is permitted, the SAM 65 uses a corresponding key to decipher the encrypted random number from the BPF carrier device. The SAM 65 further generates its own random number and concatenates the random number generated by the SAM 65 with the random number generated by the BPF carrier device 120. The concatenated number is then encrypted using the appropriate key and returned to the instrument processor.

As described above, the SAM 65 stores a counter for recording the number of failed operations, which in this example would be failed authentication events, since the last successful authentication event. If the maximum number of failed authentication events occurs, the authentication process is blocked. This protects against spurious probing of the system to attempt to learn details of the security mechanisms. If the authentication is permitted to proceed, the instrument then sends the encrypted concatenated numbers to the BPF carrier device to allow it to authenticate the SAM 125. The BPF carrier device then uses the appropriate key to decrypt the encrypted numbers and to extract the random number originally generated by the BPF carrier device. This extracted random number is compared with the number stored on the BPF carrier device 130. If the numbers match, the BPF carrier device encrypts the random number generated by the SAM 65, and returns 135 this to the instrument 6, to allow the SAM to subsequently authenticate the BPF carrier device. The encrypted number is sent to the SAM 65, which decrypts the number and compares it with the original random number it generated 140. If the decrypted number matches the random number stored on the SAM 65 then the SAM 65 returns a message to the instrument processor 25 to indicate a successful mutual authentication 145. If not, a further attempt is made. As described above, an authentication counter that limits the number of possible attempts is operative on this process to prevent probing of the device security.

A secure session between the instrument 6 and the BPF carrier device has now been established using a secure messaging key which is the concatenation of the random number generated by the BPF carrier device with the random number generated by the SAM 65. After this, the instrument issues the BPF carrier device with a command to set the personalisation state of the tag 150 to the next life cycle state. The instrument processor issues a command to the SAM 65 to retrieve the personalisation data for that BPF carrier device 155. The SAM 65 retrieves a customer specific key from its memory, encrypts the customer key to ensure confidentiality and creates a signature to ensure authenticity using the secure messaging keys. The SAM 65 then returns the encrypted customer keys to the instrument 160. The instrument sends the protected information via a command to program the BPF carrier device EEPROM with the encrypted customer keys 165.

Subsequent protected PROGRAM EEPROM commands are then issued to add any other critical security parameters that may be required for proper operation of the BPF carrier device, for example limit values or comparison values. Having completed processing the required program EEPROM commands, the instrument initiates another mutual authentication procedure 167 between the SAM 65 and the BPF carrier device similar to that described above 140-145, this time to complete the personalisation process and allow the BPF carrier device to be moved to the operational state. If the mutual authentication 167 is successful, the BPF carrier device can be switched to its operational state 170 to allow use of the customer keys stored in the EEPROM.

Once the personalisation process has been successfully completed, the instrument 6 sends a message indicative of this to the SAM 65, which decrements the value of the credit counter 70 accordingly. If the credit counter 70 reaches zero, the personalization allowed flags are not set to prevent any further personalization operations from taking place until the credit counter 70 is reset and the personalisation allowed flags set again. The credit counter 70 may be reset, updated or topped up by the BPMS supplier or an authorised representative using a secure frame. This involves going on-line, e.g. by placing the instrument 6 in a docking station or connecting it to a PC or terminal. The secure frame is secured by methods known in the art such as secure messaging, such as that employed by the payment industry in schemes such as that defined by Europay, MasterCard, and VISA (EMV). Going on-line for top-up may also be accompanied by downloading of any updates to the system or software. The instrument processor 25 is operable to send a get credit counter value command 175 to the SAM 65. The SAM 65 then returns the number of BPF carrier devices that may be personalised before the counter requires to be topped up 180. The instrument 6 may communicate this to an appropriate user. The credit counter is stored on an EEPROM area of the SAM 65 and the application is designed such that this area of EEPROM does not prematurely wear out.

A skilled person will appreciate that variations of the disclosed arrangements are possible without departing from the scope of the invention. For example, although the credit counter 70 is described as being decremented upon completion of each operation, it will be appreciated that the credit counter 70 may operate in an alternate manner, such as storing the number of operations performed since the last credit counter reset, incrementing the credit counter 70 each time an operation is performed and blocking performance of an operation when the credit counter 70 reaches an upper threshold value.

Furthermore, whilst the SAM 65 has been described as having one credit counter 70, it may have multiple credit counters 70. Each credit counter may be assigned to a different brand owner and/or be assigned or sub-assigned to differing tasks such as authentication or issuing of tags or each counter might be assigned or sub-assigned to a resource such as an operator or location. In this way, credit may be controlled down to instrument or resource level, allowing greater control and flexibility for the licence or BPMS provider. Although the system has been described for off-line operation with top-ups by online communication, operation may also be online and/or top-ups may be by other means, for example by providing an offline top-up code e.g. similar to that used in GSM mobile telephone Pay-As-You-Go schemes. Accordingly the above description of the specific embodiment is made by way of example only and not for the purposes of limitations. It will be clear to the skilled person that minor modifications may be made without significant changes to the operation described.

1. A brand protection feature reader and/or writer apparatus operating using a processor, wherein said apparatus is adapted to perform a pre-determined number of operations and prevent subsequent operations from being performed if the pre-determined number of operations is exceeded.

2. An apparatus as claimed in claim 1, wherein the operation is at least one of: authentication of a brand protection feature and issuing or registration of a brand protection feature.

3. An apparatus as claimed in claim 1 comprising a counter for counting the number of operations performed, thereby to determine if the pre-determined number of operations is exceeded.

4. An apparatus as claimed in claim 1 operable to co-operate with a remotely located counter to count the number of operations performed, thereby to determine if the pre-determined number of operations is exceeded.

5. An apparatus as claimed in claim 3 wherein the counter is decremented from a pre-determined maximum number of operations, thereby to determine if the pre-determined number of operations is exceeded.

6. An apparatus as claimed in claim 3 wherein the counter is incremented to a pre-determined maximum number of operations, thereby to determine if the pre-determined number of operations is exceeded.

7. An apparatus as claimed in claim 1 wherein the pre-determined number of operations and the number of operations performed are monitored within a secure application module (SAM).

8. An apparatus as claimed in claim 7, wherein the SAM is removable from the apparatus.

9. An apparatus as claimed in claim 7, wherein the SAM is further adapted to perform or take part in an authentication and/or registration operation.

10. An apparatus as claimed in claim 7 comprising at least one more SAM for performing or taking part in an authentication and/or registration operation.

11. An apparatus as claimed in claim 1 wherein the pre-determined number of operations is changeable.

12. An apparatus as claimed in claim 1 adapted to receive a command to change the number of available operations.

13. An apparatus as claimed in claim 12 adapted to receive the command from a remote location.

14. An apparatus as claimed in claim 12 adapted to receive the command using secure messaging.

15. An apparatus as claimed in claim 1 comprising means for warning when the instrument is within a defined number of the predetermined number of operations.

16. An apparatus as claimed in claim 1, wherein the predetermined number of operations is associated with a brand owner and/or an instrument and/or a user and/or an operation and/or a brand protection feature or security feature.

17. An apparatus as claimed in claim 1, wherein a plurality of predetermined numbers of operations is defined, each pre-determined number associated with a different brand owner and/or user and/or operation and/or brand protection feature or security feature.

18. An apparatus as claimed in claim 17 wherein each of the predetermined numbers of operations is associated with its own dedicated counter.

19. An apparatus as claimed in claim 18 adapted to identify which counter to use by obtaining data from the instrument and/or a user and/or from a tag.

20. An apparatus as claimed in claim 1 comprising means for re-setting or refreshing the predetermined number of operations in the event that the number of actual operations approaches or exceeds the predetermined number.

21. An apparatus as claimed in claim 20 wherein the predetermined number is re-set or refreshed on receipt of payment from a user.

22. An apparatus as claimed in claim 1 adapted to read and/or write one or more of one dimensional or two dimensional bar codes; RFID tags; fluorescent tags.

23. A brand protection management system (BPMS) adapted to collect authentication data from one or more apparatuses operating using a processor, wherein said one or more apparatuses is adapted to perform a pre-determined number of operations and prevent subsequent operations from being performed if the pre-determined number of operations is exceeded.

24. A method, operated using a processor, for collecting revenue for using a brand protection management system comprising monitoring the number of operations performed by one or more brand protection feature reader and/or writer apparatuses in the system and charging on the basis of the number of operations performed.

25. A method as claimed in claim 24 comprising setting a pre-determined number of allowed operations; providing one or more instruments operable to limit the number of operations that can be performed, and collecting revenue based on that pre-determined number.
